(19) United States
(12) Patent Application Publication
(10) Pub. No.: US 2003/0123147 A1
(43) Pub. Date: Jul. 3, 2003

(54) Film for forming 3D image display body and production method of 3D image display body

(76) Inventors: Sadeg M. Faris, Pleasantville, NY (US); Yashiro Minami, Joetsu-shi (JP); Yingqiu Jiang, Sunnyvale, CA (US); Kazuo Maeda, Joetsu-shi (JP); Yuen-Ming Chang, Elmsford, NY (US); Yuzuru Ohkawara, Joetsu-shi (JP); David C. Swift, Cortlandt Manor, NY (US); Adam W. Divelbiss, Wappingers Falls, NY (US)

Correspondence Address: Gerow D. Brill, Reveo, Inc., 85 Executive Blvd., Elmsford, NY, 10523, US

(21) Appl. No.: 10/035,839

(22) Filed: Dec. 31, 2001

(51) Int. Cl. G02B 27/22; G02B 27/26

(52) U.S. Cl. 359/465; 359/462

(57) ABSTRACT

A film for forming a 3D display body capable of obtaining a 3D image having higher display quality and a higher cubic feeling, by developing a 3D image containing right-eye image display portions a and left-eye display portions b in mixtures, wherein a laminate phase difference film 3 is formed by laminating, on a transparent support member 1, a plurality of phase differences films 3′ such as a polycarbonate film or stretched PVA film having birefringence in such a fashion that the optical axes thereof cross one another; predetermined portions of the laminate phase difference film 3 are removed; an appropriate synthetic resin 6 is packed into the removed portions and are set to the right-eye image display portions a; and portions of the laminate phase difference film 3 other than the right-eye image display portions a are set to the left-eye image display portions b.

### BACKGROUND OF THE INVENTION

This invention relates to a film for forming a 3D image display body for developing a 3D image, and a production method of the 3D image display device.

A 3D image apparatus, such as the one described in U.S. Pat. No. 5,327,285, has been proposed in the past. As shown in FIG. 1 of the accompanying drawings, this 3D image apparatus includes a film 52 having right-eye image display portions a and left-eye image display portions b juxtaposed alternately with one another and bonded to the surface of a liquid crystal display member 51. When light emission of the liquid crystal display member 51 is controlled to develop a predetermined image, the right-eye image display portions a, create the right-eye image and the left-eye image display portions b, the left-eye image. The right-eye image display portions a and the left-eye image display portions b are constituted so that the vibration direction of polarized light forming the right-eye image from the right-eye image display portions a describes an angle of 90° to the vibration direction of polarized light forming the left-eye image from the left-eye display portions b. In other words, the x component of the right-eye image comprising two components x and y, for example, has a phase difference of 180° (π) to the x component of the left-eye image comprising likewise two components x and y. Therefore, when an observer wearing polarized light glasses comprising a right-eye lens equipped with a polarizing plate transmitting only a right-eye image and a left-eye lens equipped with a polarizing plate transmitting only a left-eye image views the image, the observer can realizes a cubic image.

As shown in FIG. 2 of U.S. Pat. No. 5,327,285 described above, the film on which the right-eye image display portions a and left-eye image display portions b are juxtaposed uses a polarizing film (called also a “phase difference film” or “½ wavelength plate”) of a stretched PVA (polyvinyl alcohol) subjected to iodine treatment.

However, only a sheet of phase difference film cannot functions as the ½ wavelength plate over broad range of visible rays of light, and this film involves the problem that the wavelength range in which it can correctly function as the ½ wavelength plate and can convert the polarizing direction is limited to a narrow range.

The explanation will be given more concretely. A phase difference film having a phase difference value in the proximity of 275 nm is generally used for such an application to convert (rotate) the vibration direction of polarized light by 90°. In this case, the phase difference film can play the role of the ½ wavelength plate for light having a wavelength near 550 nm (green region) but does not function as a correct ½ wavelength plate for a short wavelength band (blue region) and a long wavelength band (red region). (In other words, the polarizing direction is not rotated under the condition of complete linearly polarized light and polarization becomes elliptically polarized light). Consequently, when the right-eye image display portion a and the left-eye image display portion b are formed by using a sheet of such a phase difference film, the vibration directions of both right-eye image and left-eye image do not orthogonally cross one another under the linearly polarized state. The result is that a double image and color deviations occur. The display quality as a cubic image cannot be improved.

The present invention provides a film for forming a 3D image display body in which right-eye image display portions a, and left-eye display portions b exist in mixture and which can develop an excellent 3D image.

### BRIEF DESCRIPTION OF THE DRAWINGS

The present invention will be explained with reference to the accompanying drawings:

FIG. 1 is an explanatory view of a 3D image apparatus;

FIG. 2 is a structural explanatory view of an embodiment of the present invention;

FIG. 3 is a graph showing the characteristics of a laminate phase difference film according to the present embodiment.

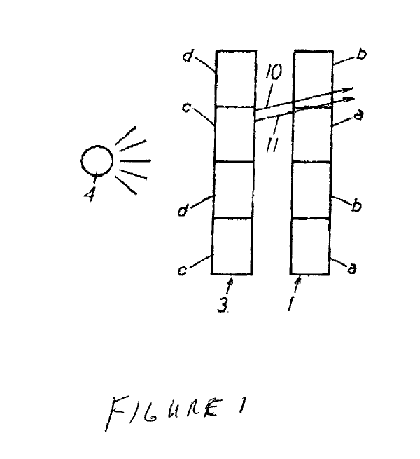

### DETAILED DESCRIPTION OF THE INVENTION

According to one aspect of the present invention, there is provided a film for forming a 3D image display body, for developing a 3D image containing right-eye image display portions a and left-eye image display portions b in mixture, wherein a laminate phase difference film is formed by laminating, on a transparent support 1 (support member), a plurality of phase difference films 3 such as polycarbonate film or stretched PVA film having birefringence in such a fashion that their optical axes cross one another. Predetermined portions of the laminate phase difference film 3 are removed. An appropriate synthetic resin 6 is packed into the removed portions and set to the right-eye display portions a. Portions of the laminate phase difference film 3 other than the right-eye image display portions a are set to the left-eye image display portions b.

According to another aspect of the present invention, there is provided a film for forming a 3D image display body, for developing a 3D image containing right-eye image display portions a and left-eye image display portions b in mixture, wherein a laminate phase difference film 3 is formed by laminating, on a transparent support member 1, a plurality of phase difference films 3′ such as polycarbonate film or stretched PVA film having birefringence in such a fashion that the optical axes thereof cross one another; predetermined portions of the laminate phase difference film 3 are removed; an appropriate synthetic resin 6 is packed into the removed portions and are set to the left-eye image display portions b; and portions of the laminate phase difference film 3 other than the left-eye image display portions b are set to the right-eye image display portions a.

According to still another aspect of the present invention, there is provided a method of producing a 3D image display body for developing a 3D image containing right-eye image display portions a and left-eye image display portions b in mixture, comprising the steps of depositing, on a transparent support member 1 not having birefringence, a laminate phase difference film 3 formed by laminating a plurality of phase difference films 3′ such as a polycarbonate film or stretched PVA film birefringence in such a fashion that their optical axes cross one another; removing predetermined portions of the laminate phase difference film 3; juxtaposing a plurality of grooves in such a fashion as to extend from one of the laminate sides of the phase difference film 3 to the other; packing an appropriate resin 6 into the grooves; and laminating or bonding a display member 5 with, or to, the laminate phase difference film 3 after packing of the synthetic resin 6.

Since a plurality of phase difference films 3 are laminated in such a fashion that their axes cross one another, it is possible to acquire a ½ wavelength plate (laminate phase difference film 3) capable of converting (rotating) a vibration direction of polarized light over a broad wavelength range without collapsing the polarized light state.

When used, this laminate phase difference film 3 allows the vibration direction of polarized light of the right-eye image from the right-eye image display portion a and the vibration direction of polarized light of the left-eye image from the left-eye image display portion b to cross each other at 90° under the linearly polarized state over a broad wavelength range. In consequence, when an observer views the image using dedicated polarized light glasses, the double image and the color deviation can be eliminated and an image having an extremely high cubic feeling can be obtained

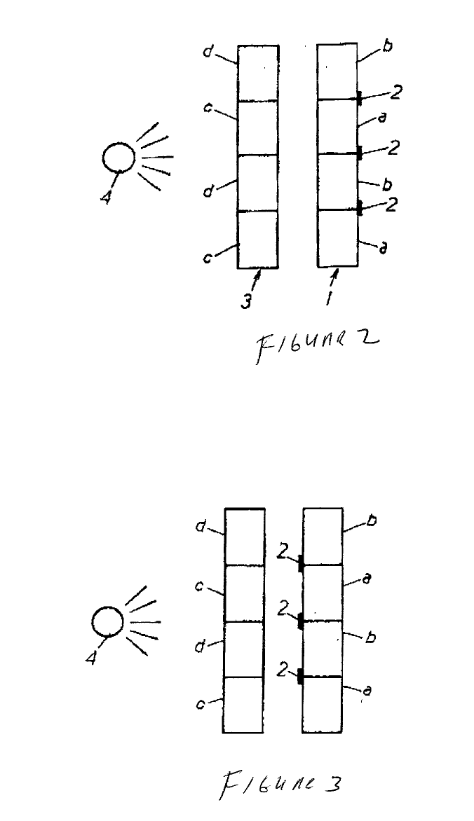

FIG. 2 shows an embodiment of the present invention, which will be hereinafter explained in detail. A plurality of phase difference films 3 are serially laminated on a transparent support member 1 (an about 1 mm-thick glass sheet or cellulose acetate butylate (CAB) sheet, for example) through an adhesive 2 (a UV-setting resin, for example) and are bonded by an adhesive 4 (a UV-setting resin, for example) in such a fashion that their optical axes cross one another. UV rays are then irradiated to set the UV-setting resins. Incidentally, the support member 1 is most preferable a glass sheet not having birefringence. The adhesives 2 and 4 may be those adhesives that are transparent and can fix the films 3.

The phase difference film 3 is a known phase difference plate, and is for example, a polycarbonate film, that can rotate the vibration direction of light of a specific wavelength band under the linearly polarized state (can rotate by 90° when the angle between the optical axis and the vibration direction is set to 45°), and has birefringence. Incidentally, it is possible to use a uniaxially stretched PVA film (about 70 μm thick) having similar properties to the polycarbonate film in place of the polycarbonate film.

As to the crossing angles of a plurality of phase difference films 3, the angle θ k of each ½ wavelength film is given by θ k=(2k−1)·θ/2n (where k is an integer of 1 to N) when the number of laminated films is N and the angle of the outgoing direction of linearly polarized light after the transmission through the wavelength film is θ with the incidence direction of the linearly polarized light being the reference (0°). Therefore, the crossing angles of the phase difference films 3′ are decided from this equation.

In this embodiment, three polycarbonate films 3 having a phase difference value of 230 nm measured at a wavelength of 550 nm are laminated to give a laminate phase difference film 3. The crossing angles of the phase difference films 3 are 15°, 45° and 75° (determined by the equation given above) from the incidence side, respectively. FIG. 3 shows the characteristics of this laminate phase difference film 3. It has been confirm clearly from FIG. 3 that the laminate phase difference film 3 of this embodiment has polarized light rotation performance of 90° in a broadband of the visible ray region.

Predetermined portions (three layers of phase differences films 3) of this laminate phase difference film 3 are subsequently cut and removed by a ultra-hard blade (saw blade, etc) in such a manner as to form a plurality of parallel grooves extending from one of the sides to the other of the laminate phase difference film 3 in juxtaposition with one another. The width of each groove and the groove pitch are in conformity with the pixel pitch of the display member 5 (liquid crystal display member) to be combined.

When a part of the laminate phase difference film 3 is removed in this way, the portion, at which the property of rotating the vibration direction of polarized light by 90° is not exhibited, is fabricated.

Next, an appropriate synthetic resin 6, such as a colorless, transparent, UV-setting resin having a refractive index equal to that of the phase difference film 3′ is applied into the grooves. This portion is used for the right-eye image display portion a, for example, and the rest are for the left-eye image display portions b. Incidentally, the right-eye image display portion a and the left-eye image display portion b may be reversed by using the portion buried with the synthetic resin for the left-eye image display portion b.

Very fine concavo-convexities are formed on the inner surface of the groove as a result of cutting and removal by using the ultra-hard blade. After the groove is buried with the resin, however, the very fine concavo-convexities are buried and the surface becomes smooth with the result in the improvement in the optical characteristics. It has been confirm that haze can be reduced by far greatly when the resin is buried than when it is not.

The display member 5 (liquid crystal display member) and a magnet are superposed with, or bonded to, each other by a suitable adhesive to obtain a 3D image display body.

The production method described above can produce the 3D image display body capable of developing an excellent 3D image by using the film in which the right-eye image display portions a and the left-eye image display portions b are juxtaposed.

When an observer views the image from the 3D image display body by wearing polarized light glasses comprising a right-eye lens equipped with a polarizing plate, that transmit only the right-eye image from the right-eye image display portions a and a left-eye lens equipped with a polarizing plate, that transmits only the left-eye image (the image constituted by the rays of light vibrating in the direction crossing orthogonally the vibration direction of the rays of light constituting the right-eye image) from the left-eye image display portions b, the observer can realize this image as a cubic image.

As described above, this embodiment uses the laminate phase difference film 3 produce by laminating a plurality of phase difference film 3′ in such a fashion that their optical axes cross one another. Therefore, the laminate phase difference film 3 can rotate by 90° all of R (red), G (green) and B (blue) over a broad wavelength band to substantially the same extents without collapsing the polarized state (providing the characteristics shown in FIG. 3). In consequence, the vibration direction of light of the right-eye image from the right-eye image display portion body a and light of the left-eye image from the left-eye image display portion body b cross one another as orthogonally as possible, and a high quality 3D image display body that eliminates the double image and the color deviation can be obtained.

1. A film for forming a 3D image display body, for developing a 3D image containing right-eye image display portions and left-eye image display portions in mixture, characterized in that:
a laminate phase difference film is formed by laminating, on a transparent support, a plurality of phase difference films such as a polycarbonate film or stretched PVA film having birefringence in such a fashion that the optical axes thereof cross one another;
predetermined portions of said laminate phase difference film are removed;
an appropriate synthetic resin is packed into said removed portions and are set to said right-eye image display portions; and
portions of said laminate phase difference film other than said right-eye image display portions are set to said left-eye image display portions.

2. A film for forming a 3D image display body, for developing a 3D image containing right-eye image display portions and left-eye image display portions in mixture, characterized in that:
a laminate phase difference film is formed by laminating, on transparent support, a plurality of phase difference films such as a polycarbonate film or stretched PVA film having birefringence in such a fashion that the optical axes thereof cross one another;
predetermined portions of said laminate phase difference film are removed;
an appropriate synthetic resin is packed into said removed portions and are set to said left-eye image display portions; and
portions of said laminate phase difference film other than said left-eye image display portions are set to said right-eye image display portions.

3. A method of producing a 3D image display body for developing a 3D image containing right-eye image display portions and left-eye image display portions in mixture, comprising the steps of:
depositing a laminate phase difference film formed by laminating, on a transparent support not having birefringence, a plurality of phase difference films such as a polycarbonate film or stretched PVA film having birefringence in such a fashion that the optical axes thereof cross one another;
removing predetermined portions of said laminate phase difference film;
juxtaposing a plurality of grooves in such a fashion as to extend from one of the sides of said phase difference film to the other;
packing an appropriate resin into said grooves; and laminating or bonding a display member with, or to, said laminate phase difference film after packing of said synthetic resin.
